(19) United States
(12) Patent Application Publication
(10) Pub. No.: US 2015/0068164 A1
(43) Pub. Date: Mar. 12, 2015

(54) Film wrapper packaging machine

(71) Applicant: Genyuan Chen, City of Industry, CA (US)

(72) Inventor: Genyuan Chen, City of Industry, CA (US)

(21) Appl. No.: 13/987,839

(22) Filed: Sep. 9, 2013

(51) Int. Cl. B65B 11/48; B65B 53/02; B29C 65/18; B65B 61/06

(52) U.S. Cl. CPC B65B 11/48; B65B 61/06; B65B 53/02; B29C 65/18
USPC 53/548; 53/556

(57) ABSTRACT

A film wrapper packaging machine with a main housing, a film roll holder, a film roll, a heated film cutting rod, a film warming housing, a rod temperature sensor, a film warming housing temperature sensor, a film warming heater assembly, a digital LED readout, a rod temperature control setting button, a film warming housing temperature control setting button, a plurality of LED indicator lights, a micro processor and associate digital control circuitry. The microprocessor and digital controls help maintain consistent even temperature of the cutting rod and the film worming housing. The heating element of the cutting rod is protected by a rigid exterior housing that reduces the chance of breakage of the heating element.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of packaging equipment and more specifically to a film wrapper packaging machine. In the process of packaging certain food items, it is usefully to wrap them in thin plastic film.

To this end, film wrapping machines have been developed and marketed that hold a roll of film on top of a housing. The film is drawn out by a user and placed over the food to be wrapped. The food, which is usually placed in a paper or plastic tray, has been placed on a warming panel on top of the housing. The user cuts the plastic film by laying it on the film cutting rod, and wraps the film under the food tray where heat from the warming panel causes the film to be slightly welded and adhere to itself, thereby effectively wrapping the food item in plastic film. .

Although current film wrapping machines do an adequate job of wrapping foods, there are some deficiencies in the current designs. First, the temperature setting of the rod and of the heating panel are done by manual controls and can vary by as much as ten degrees F. during operation. This variation in temperature can affect the proper sealing of the plastic film that is trapped between the food tray and the heating panel. Second, The heating element of the cutting rod portion of current machines is very fragile and can be broken if mishandled. Finally, the heating panel itself tends to be heated unevenly by the heating element under it, thereby causing less than satisfactory seals of the wrapped film.

### BRIEF SUMMARY OF THE INVENTION

The primary object of the invention is to provide an improved film wrapper packaging machine that gives greater control and consistency of temperature for the cutting rod portion and the heating plate portion.

Another object of the invention is to provide an improved film wrapper packaging machine whose heating elements are lass prone to breakage than other film wrapping packaging machines.

Another object of the invention is to provide an improved film wrapper packaging machine that uses digital controls and readouts to allow for easy operation of the machine.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed film wrapper packaging machine comprising: a main housing, a film roll holder, a film roll, a heated film cutting rod, a film warming housing, a rod temperature sensor, a film warming housing temperature sensor, a film warming heater assembly, a digital LED readout, a rod temperature control setting button, a film warming housing temperature control setting button, a plurality of LED indicator lights, a micro processor and associated circuit board components, said film warming housing being made from rigid metal and having a flat top plate for placing items to be wrapped, said film roll holder have left and right holding members capable of rotatably retaining said film roll in a parallel close proximity to the top of said main housing, said film roll cutting rod held in a position parallel to and in front of said film roll, said film warming housing retaining said film warming heater assembly in a manner that provides even heat to the top surface of said film warming housing, said rod temperature sensor mounted mid way on said heater rod, said film warming temperature sensor located on the inside wall of said film warming housing, said microprocessor controlled by user inputs to said rod temperature control setting button and said film warming housing temperature control button, said temperature settings capable of being viewed on said LED readout, said rod temperature sensor and said film warming housing temperature sensor electrically connected to said microprocessor allowing said microprocessor to make adjustments to the temperature of said heating assemblies as needed for maintaining constant temperature or for changing temperature as directed by said user and said LED indicator lights letting the user know if said heater assemblies are on or off.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a side section view of the heater housing

FIG. 3 is a block diagram of the heater controls

FIG. 4 is a front view of the temperature control and readout panel

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

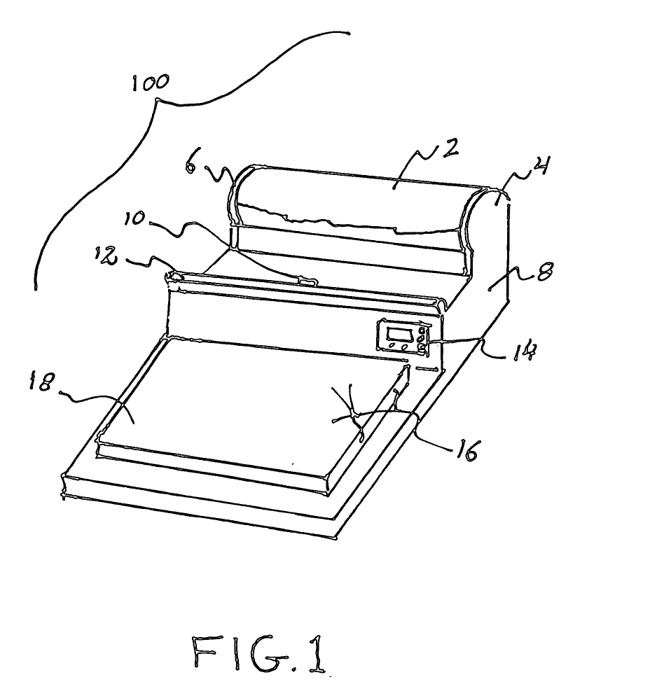

Referring now to FIG. 1 we see a perspective view of the present invention. A main housing 8 includes a film roll holder 4, 6 that rotatably retains a standard roll of plastic packaging film 2. The sheet of film from the roll 2 can be pulled forward by the user. A food item, usually placed on a paper or plastic tray, is then placed on a heated metal box assembly 16. The sheet is cut by heated rod 12 that is placed in front of and parallel to the film roll 2. Heat sensor 12 tracks the temperature of the heater rod 12 and sends signals to a microprocessor and related circuit located within housing 8 which turns the heater element on or off as needed to maintain a consistent desired temperature. The user can then wrap the food item with the sheet of plastic and then wrap the excess sheet under the food item where it is semi welded together by the action of the heated top 18 of the metal box assembly 16. A digital display 14 shows the temperature of the heated surface 18 and includes control buttons to adjust the temperature up or down.

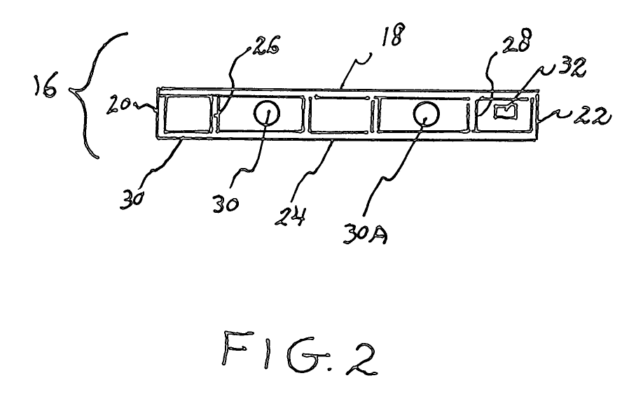

FIG. 2 shows a side section view of the heated box assembly 16. The box is comprised of a top plate 18, side walls 20, 22 and a bottom plate 24. Heater rods 30, 30A are spaced within the inside of the box 16 and metal baffle panels 24, 26 help spread the heat evenly throughout the box. The even heating insures that the temperature of top surface 18 of the box assembly 16 is consistent over the entire surface. Heat sensor 32 measures the temperature of the wall of the box and sends the information to the microprocessor 34 located within housing 8. Empirical testing has shown what temperature the sensor needs to see and maintain in order to produce ideal welding results for the plastic sheet selected by the user. Different thickness, and chemical composition of sheets require different temperature settings. A settings chart is provided to the user help them choose the proper temperature for the type of plastic sheet selected.

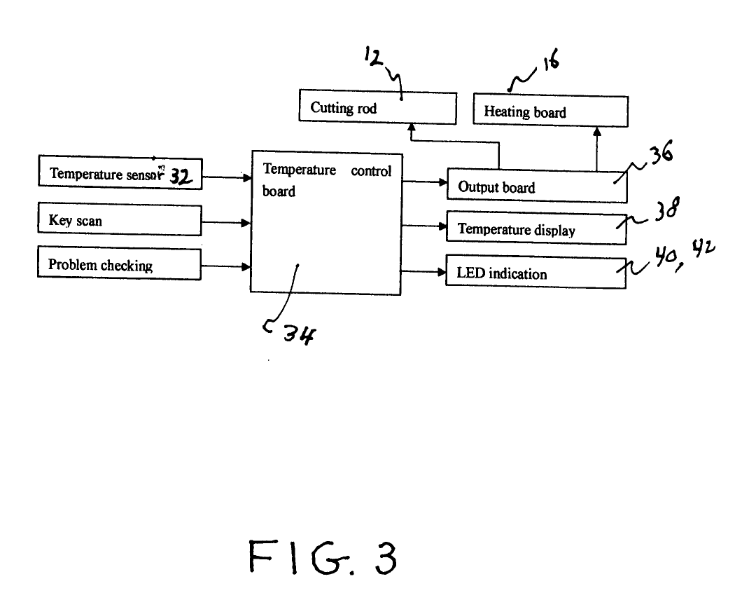

FIG. 3 is a block diagram of the operation of the invention 100. Temperature sensors 10, 32 send information to the temperature control microprocessor assembly 34. Based on temperature inputs, the control board 34 sends instructions to an output board which in turn operates the cutting rod heater 12 and the heater element within the heating box assembly 16. The Temperature control board also sends a signal to create the temperature display 38 and LED indicators 40, 42. The digital control of the heating elements 12, 30 keep them within a one degree F. variation of the intended setting. This is a great improvement over previous film wrap machines that rely on mechanical bi metal heat sensors whose dead band is approximately plus or minus five degrees F.

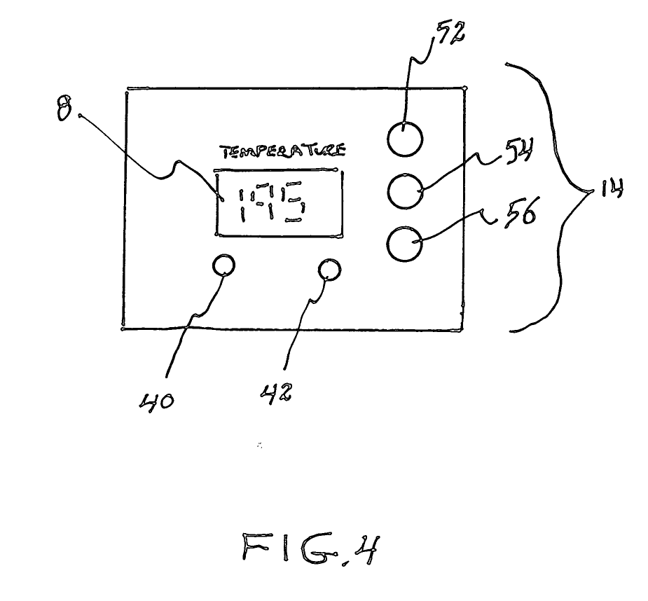

FIG. 4 is a front view of the digital display and control panel 14. Button 52 is an on/off switch. Button 54 is the temperature “up” switch and Button 56 is the temperature “down” switch. LED 40 indicates that the heater box is on or off. LED 42 indicates whether the cut off rod in on or off. The temperature 38 is shown by an LED digital display.

The heated cutting rod the rod 12 and heat sensor 10 insures that the rod 12 is maintained at the ideal temperature. The fragile heating element within the rod is supported and reinforced by the surrounding rigid rod and thereby is less prone to breakage.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. film wrapper packaging machine comprising:
a main housing;
a film roll holder;
a film roll;
a heated film cutting rod;
a film warming housing;
a rod temperature sensor;
a film warming housing temperature sensor;
a film warming heater assembly;
a digital LED readout;
a rod temperature control setting button;
a film warming housing temperature control setting button;
a plurality of LED indicator lights;
a micro processor and associated circuit board components;
said film warming housing being made from rigid metal and having a flat top plate for placing items to be wrapped;
said film roll holder have left and right holding members capable of rotatably retaining said film roll in a parallel close proximity to the top of said main housing;
said film roll cutting rod held in a position parallel to and in front of said film roll;
said film warming housing retaining said film warming heater assembly in a manner that provides even heat to the top surface of said film warming housing;
said rod temperature sensor mounted mid way on said heater rod;
said film warming temperature sensor located on the inside wall of said film warming housing;
said microprocessor controlled by user inputs to said rod temperature control setting button and said film warming housing temperature control button;
said temperature settings capable of being viewed on said LED readout;
said rod temperature sensor and said film warming housing temperature sensor electrically connected to said microprocessor allowing said microprocessor to make adjustments to the temperature of said heating assemblies as needed for maintaining constant temperature or for changing temperature as directed by said user and
said LED indicator lights letting the user know if said heater assemblies are on or off.

2. A film wrapper packaging machine as claimed in claim 1 wherein said heater assembly members are digitally controlled by said microprocessor and said heating elements can maintain constant heat at the desired heat setting plus or minus one degree.

3. A film wrapper packaging machine as claimed in claim 1 wherein said heated film cutting rod includes a rigid and protects the heating element within said rod from breakage.

4. A film wrapper packaging machine as claimed in claim 1 wherein said even spacing of said film warming heating heater assembly between metal partition walls within said housing create an even and constant temperature on the top surface of said film warming housing.
